(19) United States
(12) Patent Application Publication
(10) Pub. No.: US 2004/0099970 A1
(43) Pub. Date: May 27, 2004

(54) Tray column with deentrainment packing below the tray

(75) Inventors: Egon Zich, Leichlingen (DE); Helmut Jansen, Dormagen (DE); Thomas Rietfort, Bottrop (DE); Bjorn Kaibel, Hilden (DE)

Correspondence Address: THE FIRM OF KARL F ROSS, 5676 RIVERDALE AVENUE, PO BOX 900, RIVERDALE (BRONX), NY, 10471-0900, US

(73) Assignee: JULIUS MONTZ GmbH

(21) Appl. No.: 10/463,838

(22) Filed: Jun. 17, 2003

(30) Foreign Application Priority Data
Jul. 5, 2002 (DE) 10230325.8

(51) Int. Cl. B01D 47/14

(52) U.S. Cl. 261/114.5

(57) ABSTRACT

A tray column in which a deentrainment element or packing is provided between the trays, is further equipped with a preseparator, especially in the form of plates, structural shapes, foils and/or at least one grate, spaced above a mass transfer tray and improving the efficiency by allowing trays to be closer together and preventing the migration of foam or bubble layers above the tray.

### FIELD OF THE INVENTION

Our present invention relates to a tray column for effecting mass transfer or heat exchange between the gas phase and a liquid phase and, more particularly, to a column provided with mass transfer and/or heat exchange trays and a deentrainment element or packing disposed between such trays.

### BACKGROUND OF THE INVENTION

Tray columns are used for a number of heat exchange and mass transfer processes between liquids and gases.

The liquid can form a liquid layer on each of the trays and can overflow from tray to tray while passing generally downwardly in the column while the gas can pass through the liquid layers on the tray and generally moves upwardly through the column. Above the liquid level on a tray or on the tray itself, a bubble, foam or like layer may be formed by the action of the gas in passing through the layer from openings in the tray. To the extent that it may be undesirable for the foam or bubbling layer to reach from the underlying to the next overlying tray, U.S. Pat. Nos. 5,262,094 and 5,762,668 teach the provisions below a tray and which is between an underlying tray and an overlying tray of a deentrainment element, i.e. a packing, which can also be referred to as a demister, gas/liquid separator or the like. While such systems have been found to be effective, they may not be sufficient in all cases.

### OBJECTS OF THE INVENTION

It is, therefore, the principal object of the present invention to further limit the foam or bubbling layer in such a column and to enable a closer spacing of the trays of a column.

Another object of this invention is to provide a column for effecting mass transfer and/or heat exchange between a gas phase which and a liquid phase which can limit the possibility of a foam or bubble layer on top of the liquid layer on a tray from reaching the next tray while nevertheless holding the pressure losses in the column to a minimum.

Still another object of this invention is to provide a tray column which can improve upon the separating efficiencies of the columns previously described while holding the pressure loss to a minimum.

### SUMMARY OF THE INVENTION

These objects are attained, in accordance with the invention by providing between an upper tray and a lower tray and thus between two trays, a deentrainment element for packing as before, but with an additional preseparator in the form of sheet metal sheets or plates, structural shapes (profiles) and/or at least one grate, spaced from the mass transfer tray. More particularly, a column for effecting mass transfer or heat exchange between a gas phase and a liquid phase can comprise:

an upright column housing provided with means for introducing a gas phase rising in the column and a liquid phase descending in the column;

a plurality of trays vertically spaced apart in the housing and including a lower tray and an upper tray spaced above the lower tray for supporting layers of the liquid phase and passing the gas phase upwardly through the layers, the liquid phase flowing downwardly from tray to tray;

a deentrainment element in the housing between the lower and upper trays and positioned to separate liquid from gas above the lower tray and before passage of gas through an upper one of the two trays; and

a preseparator in the housing below the deentrainment element and spaced from the trays.

The preseparator is generally planar, spaced below the deentrainment element and comprised of sheet metal plates, structural shapes, foil or at least one grate.

The preseparator can be parallel to the trays and composed of corrugated metal plates or strips.

The preseparator can be comprised of members lying in one layer and crossing layers lying in another layer. The preseparator can be suspended from an overlying deentrainment element or tray and it is possible to suspend both the deentrainment packing and the preseparator from an overlying tray. The packing can have vertical corrugated plates having corrugation crests of adjoining plates contacting one another and corrugations of adjacent plates inclined in opposite directions and either extending linearly or along curves.

The preseparator of the invention between an overlying deentrainment element and an underlying tray ensures that the deentrainment element will not be overloaded and need not be so dense or tightly packed that it can give rise to a significant pressure drop in the column. The deentrainment packing and preseparator work together to enable the spacing between trays to be reduced and the efficiency in the heat exchange and/or mass transfer to be increased. Back mixing of the liquid is reliably prevented and the distribution of liquid on the tray is improved. Furthermore, existing tray columns provided with deentrainment packing can be retrofitted with such preseparators in a simple manner.

### BRIEF DESCRIPTION OF THE DRAWING

The above and other objects, features, and advantages will become more readily apparent from the following description, reference being made to the accompanying drawing in which:

FIG. 1 is a diagrammatic illustration of a portion of a column illustrating a first embodiment of the invention;

FIG. 2 is diagrammatic showing a second embodiment at a larger scale and detailing the openings in which the trays through the gas phase can pass;

FIG. 3 is a cross sectional view taken along line III-III of FIG. 1;

FIG. 4 is a cross section through a grate forming one of the upper separator layers in another embodiment;

FIG. 5 is a cross section through a grate of one of the layers of a separator in accordance with another embodiment;

FIG. 6 is a diagram of a portion of the deentrainment packing; and

FIG. 7 is a view similar to FIG. 6 of a portion of another deentrainment packing.

### SPECIFIC DESCRIPTION

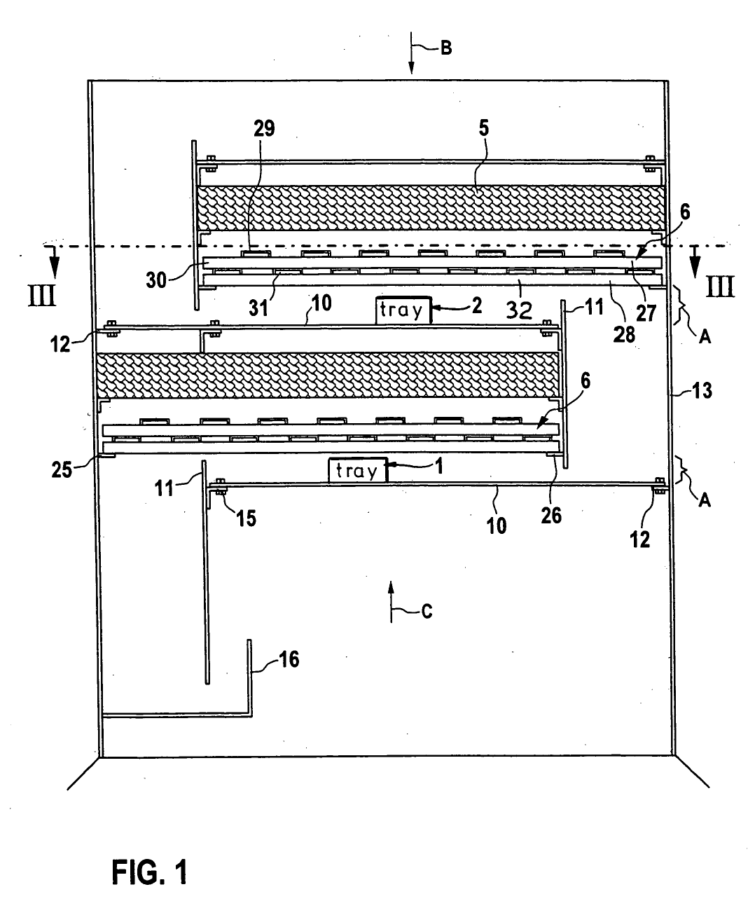

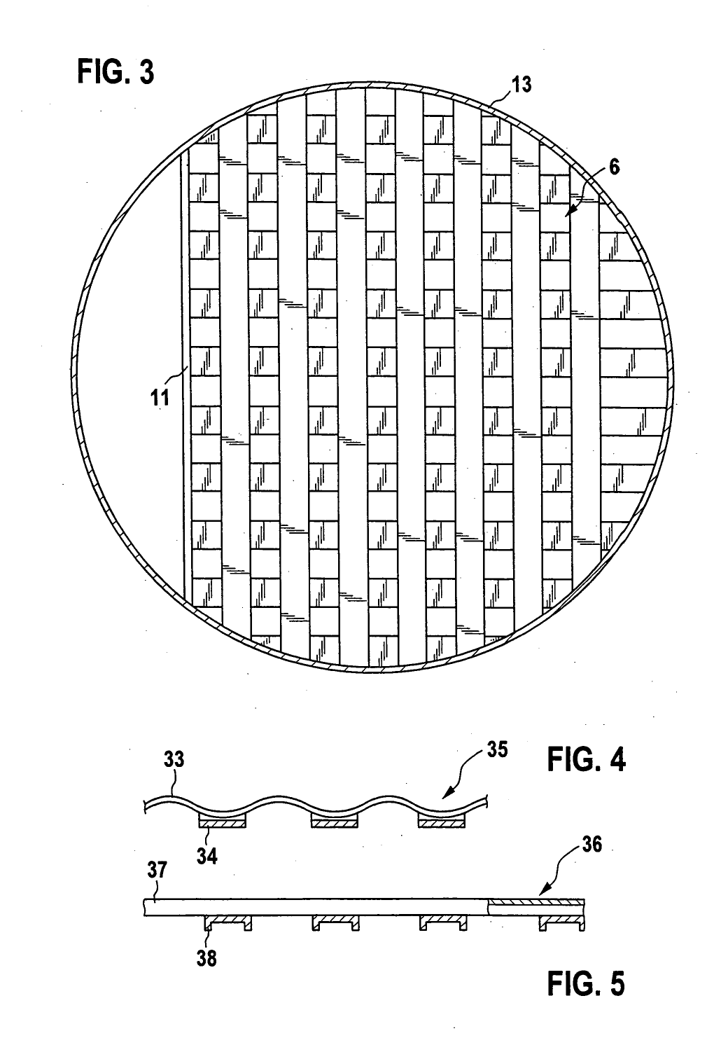

In FIG. 1, two trays, tray 1 and tray 2, have been identified, each tray comprising a plate 10 having a weir 11 along an edge and over which the liquid phase can flow. As can be seen from FIG. 1, for example, the plates 10 can be supported on ledges 12 affixed to the column housing 13 and on brackets 15 secured to the weir 11 which is a plate extending along a chord of the housing 13 (see FIG. 3).

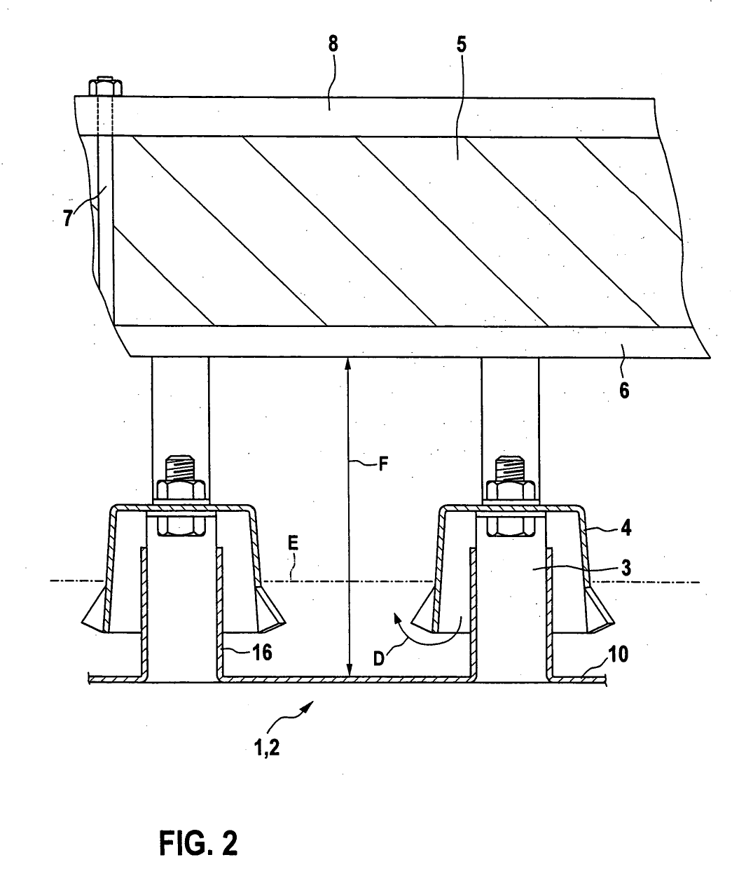

The plates 10 are provided as passages allowing the upward flow of the gas phase. These passages are bores 3 formed in the plate 10 of trays 1 and 2 and extended upwardly in cylindrical tubes 16 not shown in FIG. 1 but understood to be provided all over each of the plates 10. The passages 3 are covered by caps 4 which open downwardly and allow the gas to bubble through the liquid on each tray, passing upwardly as represented by the arrow D in FIG. 2. The caps 4 open below the liquid level which is represented by the dot-dash line E in FIG. 2 and, of course, is determined by the height of the weir 11 above each plate 10. The region F above the liquid level E may contain a foam formed by the bubbling of the gas through the liquid and which is limited by a separator 6 and can permit development of a higher bubble or foam layer which is suppressed by the deentrainment packing 5.

A collector 16 may be provided to collect the liquid from a lowermost tray of a set.

In FIG. 1, the means for introducing the liquid phase to the column is represented by the arrow B and the means for introducing the gas phase is represented by the arrow C.

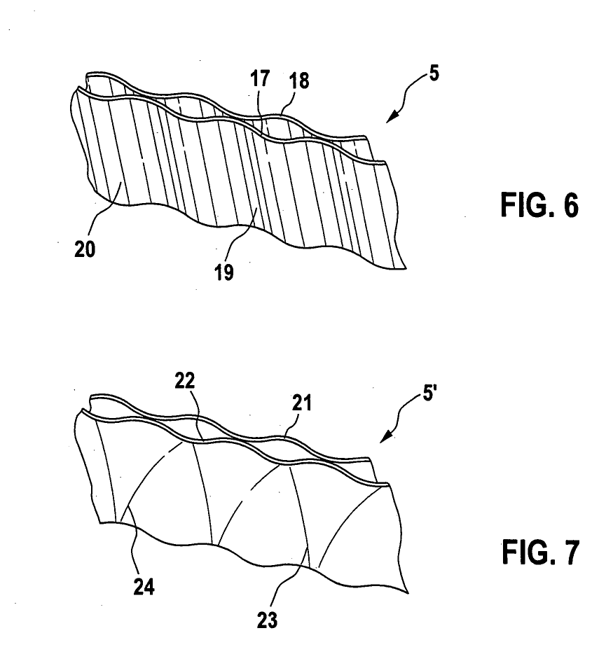

A can be seen from FIG. 2, each deentrainment packing 5 and the respective preseparator 6 may be mounted above the tray 1 or 2 or suspended below an overlying tray by rods 7 and a press pad or hold-down 8 which maintains the packing plates of the deentrainment element 5 in position. The deentrainment element 5 may be an ordered packing structure which can comprise a multiplicity of vertically oriented corrugated plates 17, 18 (FIG. 6), for example, with rectilinear corrugations 19 and 20 which cross one another and in which the adjacent plates have their lateral surfaces in contact with one another at the crests of their respective ribs or corrugations. Instead of corrugated plates, corrugated strips may be used.

In FIG. 7 another type of ordered packing 5′ for the deentrainment element is shown in which the plates 21 and 22 have corrugations 23 and 24 which cross one another but are curved.

The preseparator 6 may also comprise planar structures and in FIG. 1, each of the separators 6 is shown to rest on a ledge 25 attached to the wall of the housing 13 and a further ledge 26 secured to the weir-forming plate 11. Each of the preseparators 6 is here located above a tray 1 or 2 and below a deentrainment packing 5 at a distance A from the underlying tray and, parallel both to the trays and to the deentrainment element. The preseparator 6 can also lie directly below the deentrainment packing 5 as has been shown diagrammatically in FIG. 2, i.e. without a spacing between deentrainment packing 5 and the preseparator 6.

As can be seen from FIG. 1, each of the preseparators 6 can comprise two grates 27 and 28, each of which comprises a layer of mutually-spaced upper bars or strips 29 and a multiplicity of mutually-spaced lower bars or strips 30 which are orthogonal to the strips 29, i.e. cross the strips 29. The upper strips 31 and the lower strips 32 of the grate 28 maybe staggered with respect to the upper strips 29 and the lower strips 30 of the upper grate 27. The strips of each grate can be welded together.

As a general matter, the preseparator in each case may be comprised of corrugated plates or strips which are located in layers and cross one another as is shown for the corrugated upper strips 33 and lower strips 34 of the grate 35 of FIG. 4.

In FIG. 5, the grate 36 for a preseparator is shown to be comprised of upper channels 37 and lower channels 38 as an example of structural shapes which can be used to form such preseparators.

It will be apparent from FIGS. 1, 6 and 7 that the deentrainment element or packing 5 in each case, ensures a breakdown of the foam layer and thus limits the height of the foam layer and prevents an uncontrolled liquid entrainment by the gas and that the preseparators serve to promote such breakdown and separation of the gas and liquid phases above each tray.

Tests have shown a potential throughput increase of up to 50% depending upon the configurations and inclinations of the flow passages and the arrangement of the packing above each tray.

The simple constructions allow retrofitting of existing tray columns even in cases in which the trays are fixed in place. Indeed the deentrainment packing and/or the preseparator may be easily connected to existing fastening elements in most columns.

We claim:

1. A column for effecting mass transfer or heat exchange between a gas phase and a liquid phase, comprising:
an upright column housing provided with means for introducing a gas phase rising in said column and a liquid phase descending in said column;
a plurality of trays vertically spaced apart in said housing and including a lower tray and an upper tray spaced above said lower tray for supporting layers of the liquid phase and passing the gas phase upwardly through said layers, the liquid phase flowing downwardly from tray to tray;
a deentrainment element in said housing between said lower and upper trays and positioned to separate liquid from gas above the lower tray and before passage of gas through an upper one of said two trays; and
a preseparator in said housing below said deentrainment element and spaced from said trays.

2. The column defined in claim 1 wherein said preseparator is comprised of sheet metal plates, structural shapes, foils or at least one grate.

3. The column defined in claim 2 wherein said preseparator is generally planar and spaced from said deentrainment element.

4. The column defined in claim 3 wherein said preseparator is parallel to said trays.

5. The column defined in claim 4 wherein said preseparator is composed of corrugated metal plates or strip.

6. The column defined in claim 5 wherein said preseparator is comprised of members lying in a respective layer and crossing members of another layer.

7. The column defined in claim 6 wherein said preseparator is suspended from an overlying deentrainment element.

8. The column defined in claim 6 wherein said deentrainment element is suspended from an overlying tray.

9. The column defined in claim 2 wherein each of said trays has a respective deentrainment element and a respective preseparator located therebelow.

10. The column defined in claim 9 wherein said preseparators each comprise a pair of grates each composed of mutually spaced parallel arrays of crossing metal strips.

11. The column defined in claim 10 wherein each of said deentrainment elements is a packing of vertical corrugated plates having corrugation crests of adjoining plates contacting one another and corrugations of adjacent corrugated plates inclined in opposite directions.

12. The column defined in claim 11 wherein the corrugations run linearly on said plates.

13. The column defined in claim 11 wherein the corrugations of said plates are curved.
